(19) United States
(12) Patent Application Publication
(10) Pub. No.: US 2010/0042940 A1
(43) Pub. Date: Feb. 18, 2010

(54) Geofence system with integrated user interface

(75) Inventors: Steven Donald Monday, Tremont, IL (US); Joshua Robert Dalcher, Pekin, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/222,710

(22) Filed: Aug. 14, 2008

(51) Int. Cl. G06F 3/048

(52) U.S. Cl. 715/764

(57) ABSTRACT

A geofence system is provided. The geofence system includes a display device and a graphical user interface displayable on the display device. The graphical user interface is configured to display a map corresponding with a geographical area, and provide a graphical representation of a geofence. The graphical representation is overlaid on the displayed map and includes a control portion responsive to an input device configured to adjust an operational aspect of at least a portion of the geofence. The control portion is associated with a location on the map.

### TECHNICAL FIELD

The present disclosure relates generally to a geofence system and, more particularly, to a geofence system with an integrated user interface.

### BACKGROUND

Many modern machines, such as excavators, wheel loaders, on-and off-highway machines, haulers, and motor graders may include communication devices that facilitate data communication with one or more other machines and/or off-board monitoring and control systems. Such a machine may be equipped with a GPS device for monitoring position-related aspects associated with the machine (e.g., latitude and longitude, elevation, orientation, etc.) The information collected by the GPS device may be processed and analyzed by an on-board processor associated with the machine and/or delivered via a communication network to one or more other machines and/or off-board systems for monitoring and analysis.

Analysis and processing of GPS information may be implemented in a variety of industries and applications. For example, GPS information may be used by an equipment rental agency to monitor position information associated with a piece of rental equipment to ensure that the equipment remains in a pre-approved location or region. In some cases, the GPS information may be used in conjunction with a geofence system that defines a virtual boundary having a particular (and often predetermined) shape and size that defines a geographical area wherein the equipment is authorized to (or prohibited from) traveling. When a machine crosses the boundary defined by the geofence, an off-board computer system adapted to monitor the position of the equipment may generate a geofence event signal. The off-board system may transmit the geofence event signal to a machine controller, which may generate an alarm, which is provided to the machine console.

In conventional geofence applications, the on-board and/or off-board systems associated with a remote asset may include a first graphical user interface (GUI) for displaying a map associated with an area surrounding (or other associated with) the remote asset. The on-board and/or off-board systems may also include a second GUI that displays graphical information corresponding to a geofence boundary. The second GUI may provide an interface that allows a user (e.g., job-site manager, operator, and/or the owner of the asset) to specify certain operational aspects, such as a size, shape, or alarm configuration of the geofence boundary. However, monitoring and managing multiple user interfaces can be cumbersome, time consuming, and may distract the operator or asset manager from performing other, more critical operational or managerial tasks. Therefore, in order to limit the complexity associated with management and operation of a geofence system, a system and method that provides mapping and geofence configuration control capabilities in a single, integrated interface, may be advantageous.

One method and apparatus for displaying mapping and geofence boundary parameters on a single display is described in U.S. Pat. No. 6,665,613 (the '613 patent) issued to Duvall on Dec. 16, 2003. The '613 patent discloses a movable vehicle equipped with a GPS receiver, a software-programmable processor, and a communication link configured to communicate with a control center. Once a decision is made at the control center to establish or change a geofence around the vehicle at a particular location, a command signal is sent by the control center to the vehicle. The command signal may specify, based on the current (or prospective) location of the vehicle, a predetermined size and shape of the geofence. The command signal is processed by the software-programmed processor to calculate the location of points that define the perimeter of the geofence.

Although the system of the '613 patent may display certain mapping and geofence boundary parameters in a single interface, it may be limited in certain situations. Specifically, while the control center system of the '613 may display an area map associated with the machine and provide an interface for configuring the geofence boundaries, the configuration options associated with geofence are limited to selection of predetermined boundary shapes (polygons, circles, etc.) and sizes (radial distance from the center of the geofence location), and the center point of the geofence location is limited to the current home position of the vehicle. As a result, the system described in the '613 patent may not effectively support applications and job-sites that require flexibility to create boundaries with irregular shapes and sizes, and to change the location of a geofence.

Furthermore, because the control system of the '613 patent may only allow users to specify a radius associated with the predetermined shape of the boundary, it may not support selective modification of a particular portion of the boundary defined by the geofence. Consequently, users of the geofence system of the '613 patent that require expansion only of a particular portion of a geofence boundary may be forced to increase the entire radius the boundary. Such inflexibility may cause users to unnecessarily authorize access to certain portions of a job-site even though such authorization may not be required.

The system and method of the present disclosure are directed toward improvements in the existing technology.

### SUMMARY

In one aspect, the present disclosure is directed to a geofence system. The geofence system includes a display device and a graphical user interface displayable on the display device. The graphical user interface is configured to display a map corresponding with a geographical area, and provide a graphical representation of a geofence. The graphical representation is overlaid on the displayed map and includes a control portion responsive to an input device configured to adjust an operational aspect of at least a portion of the geofence. The control portion is associated with a location on the map.

In another aspect, the present disclosure is directed to a method of reconfiguring a geofence. The method includes displaying a graphical representation of the geofence, the graphical representation overlaid on a map associated with an interactive user interface and including a control portion responsive to an input device, the control portion associated with a location on the map. The method also includes detecting a user interaction with the control portion of the graphical representation of the geofence. The method further includes adjusting an operational aspect of the geofence based on the detected user interaction with the control portion.

### BRIEF DESCRIPTION OF THE DRAWINGS

FIG. 1 is a schematic illustration of an exemplary networked environment with geofence application;

FIG. 2 diagrammatically illustrates an exemplary computer system upon which a geofence application may be implemented;

FIG. 3 provides an exemplary display of a graphical user interface of a geofence system that illustrates a reconfiguration of a geofence via user interaction with a handle associated with the geofence;

FIG. 4 provides an exemplary display of a graphical user interface of a geofence system that illustrates a reconfiguration of a geofence via user interaction with a center point associated with the geofence;

FIG. 5 provides an exemplary display of a graphical user interface of a geofence system that illustrates a reconfiguration of geofences via user interaction with both handles and center points associated with the geofences; and

FIG. 6 provides an exemplary display of a graphical user interface that illustrates a reconfiguration of geofence via user interaction with a handle associated with the geofence.

### DETAILED DESCRIPTION

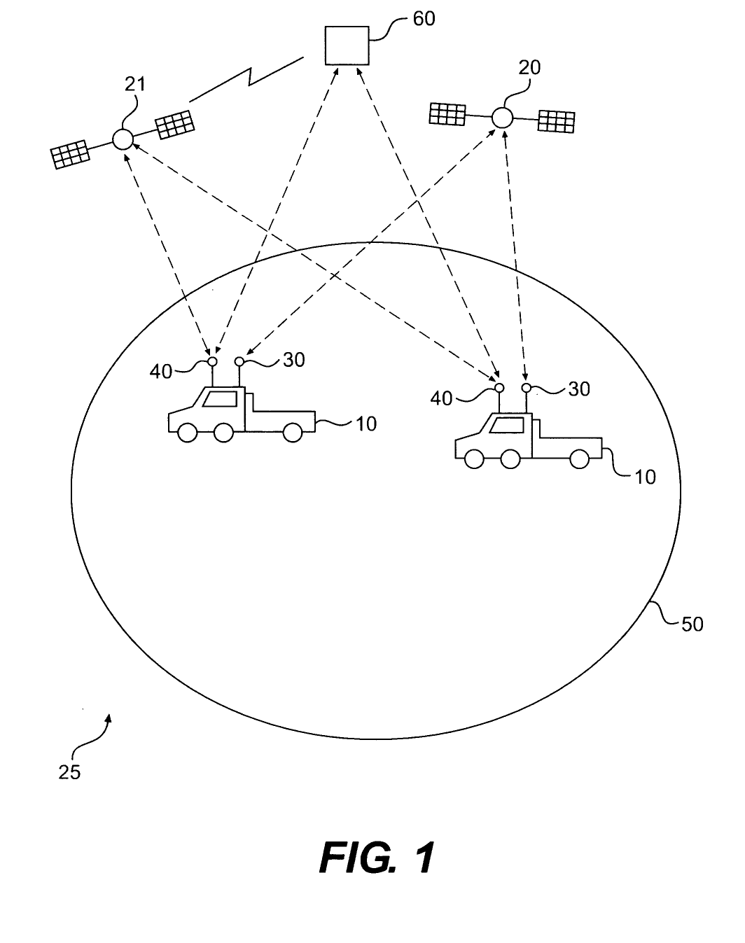

FIG. 1 schematically illustrates an exemplary networked environment 25, in which the presently disclosed geofence application(s) may be implemented. The networked environment 25 may include a number of machines 10, such as off-highway trucks, excavators, wheel loaders, or any assets that can be moved from one place to another. The networked environment 25 may also include a central control station 60. A boundary 50 may represent a geofence, which is a virtual fence of a real geographical area where machines 10 are authorized or prohibited to operate. Therefore, a geofence may not be visible at the networked environment 25. The networked environment 25 may be a construction site, a mine site, a school, a shop, a vehicle dealership, an equipment rental site, a warehouse, etc. It is contemplated that the boundary 50 may be substituted with any other regular shape, such as polygon, triangle, square, etc., or irregular shape.

Depending on the desired access of the area designated by the geofence, a geofence may be an inclusive type, which means machines 10 may only be authorized to operate inside the area defined by the geofence. Once any one of the machines 10 leaves the geofence-defined area by crossing the geofence, an alarm may be triggered, for example, at the central control station 60. A geofence may also be an exclusive type, which means the machines 10 may only be authorized to operate outside the area defined by the geofence. Once any one of the machines 10 enters the geofence defined area by crossing the geofence, an alarm may be triggered at the central control station 60. It is contemplated that a geofence may be configured to include both inclusive and exclusive capabilities.

Each one of the machines 10 may be equipped with a positioning device 30. In some embodiments, each one of the machines 10 may also be equipped with a communication device 40. The positioning device 30 may be a global positioning (GPS system) device communicating with at least one GPS satellite 20 to receive positioning data, such as latitude and longitude related to the locations of the machines 10. The positioning device 30 may be linked with the communication device 40 and may send/receive signals, such as signals including position-related data, to/from the communication device 40. In some embodiments, the positioning device 30 may be integrated with the communication device 40 as a single device.

The communication device 40 may communicate with the central control station 60 using a variety of suitable protocols, for example, radio communication, cell phone communication, wireless internet communication, etc. In some embodiments, the communication device 40 may directly communicate with the central control station 60. The communication device 40 may send signals to and receive signals from the central control station 60. The signals may include, for example, command data, position-related data, programming codes, etc. In some embodiments, the communication device 40 may indirectly communicate with the central control station 60. For example, the communication device 40 may first communicate with a satellite 21, which may then communicate with the central control station 60. The communication device 40 may send and receive signals to and from the satellite 21. The satellite 21 may send signals received from the communication device 40 to the central control station 60, and send signals received from the central control station 60 to the communication device 40.

Although not expressly shown in FIG. 1, it can be appreciated by a person skilled in the art that machines 10 may include data processing devices configured to process data received by the communication device 40, such as the command data received from the central control station 60. It is also contemplated that the networked environment 25 may further include devices such as signal transmitting towers (not shown), which may receive signals from the communication device 40, amplify the signals, and send the amplified signals to the central control station 60, or to the satellite 21.

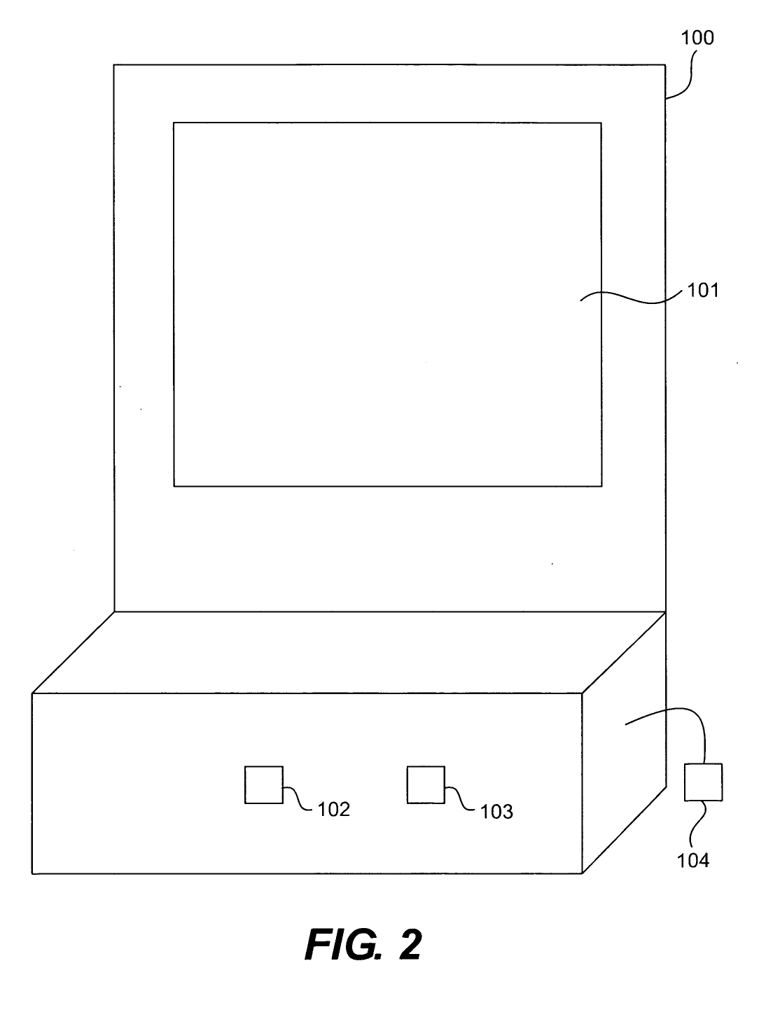

FIG. 2 diagrammatically illustrates an exemplary computer system 100 upon which a geofence application may be implemented. The computer system 100 may be employed in the central control station 60, and may be operated by a user at the central control station 60 to reconfigure a geofence (e.g., change shape, size, location, color, etc., associated with the geofence) for the networked environment 25. It is contemplated that in some embodiments, the computer system 100 may also be employed in the operating cab of a machine 10, and may be operated by the user of the machine 10.

Reconfiguration of a geofence refers to changing an operation aspect, such as shape, size, location, alarm condition when the geofence is breached, etc. The computer system 100, although shown in FIG. 2 as a desktop computer, may also be a laptop, a handheld device, an interactive touch-screen device, a heads-up display device, etc.

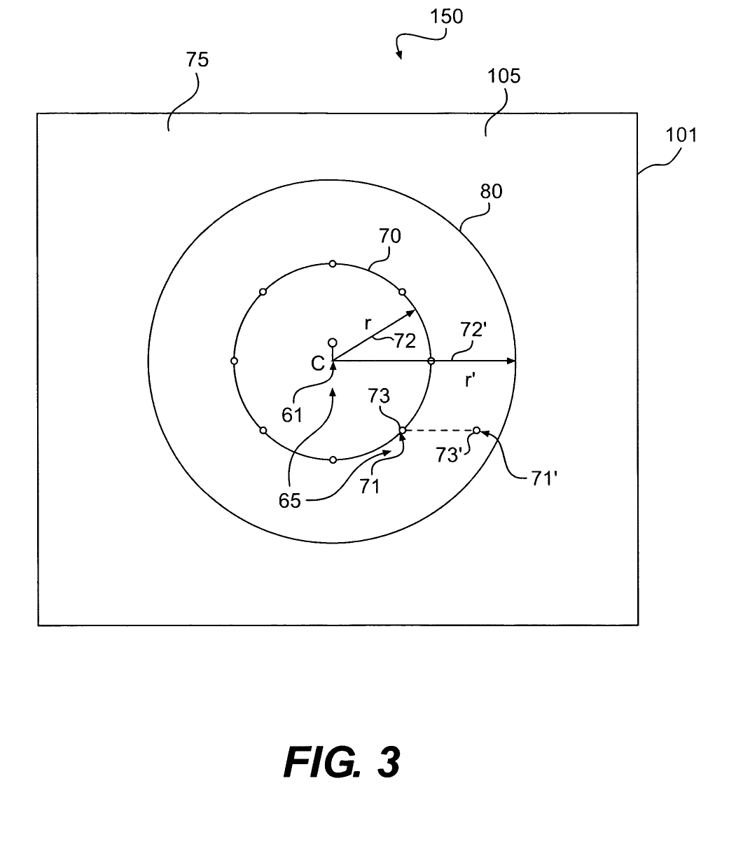

The computer system 100 may include a display device 101, a data processor 102, a memory 103, and an input device 104. The display device 101 may display an integrated graphical user interface (shown in FIG. 3), which may combine a map interface and a geofence configuration interface into one single interface, displaying a map, a geofence overlaid on the map, and a control portion associated with the geofence for reconfiguring the geofence. The data processor 102 may be configured to process data, and the memory 103 may be configured to store data. The input device 104 may be a mouse, a track point, a touch pad, or any device that can perform operation necessary to reconfigure the geofence. The input device 104 may be associated with the data processor 102 and the display device 101 via any suitable means. The data processor 102, the memory 103, and the input device 104 may be any types known in the art. The computer system 100 may include other components, such as, a hard disk drive, a cooling fan to reduce temperature of the processor, etc., which are not shown in FIG. 2.

FIG. 3 provides an exemplary display of an integrated graphical user interface (GUI) 105 of a geofence system 150 that illustrates a reconfiguration of a geofence via user interaction with a handle associated with the geofence. A user may interact with the integrated GUI 105 of the geofence system 150 through the input device 104. The geofence system 150 may receive a command signal (which is known in the art, e.g., a signal indicative of user commands of selecting, moving, etc.) through the input device 104 from the user, and perform geofence reconfiguration actions discussed in detail below in response to the received command signal. The integrated GUI 105 may be displayed on the display device 101, and configured to display a map 75 corresponding with an area associated with at least one machine 10. The integrated GUI 105 may provide a graphical representation of a first geofence 70. The graphical representation may be overlaid on the displayed map 75 and may include a control portion 65 responsive to the input device 104 and configured to adjust an operational aspect of at least a portion of the first geofence 70. For example, the user may click, select, and move (via drag-and-drop) the control portion 65, which may responsively cause changes to the operational aspect of the first geofence 70. The control portion 65 may be associated with a location on the map 75. In other words, the control portion 65 may indicate a specific location on the map 75, thus may be associated with map data, such as longitude and latitude.

The operational aspect of the first geofence 70 may include at least one of the shape, size, location, and alarm conditions associated with the first geofence 70. For example, the first geofence 70 may be represented by a circle, a triangle, etc., with a predetermined size, and located at a predetermined location. The first geofence 70 may also be associated with a set of alarm conditions. For example, the alarm conditions may include, for example, “triggering an alarm if the machine 10 crosses the boundary of the geofence 70,” or “triggering an alarm if the machine 10 is within 10 feet of the boundary of the geofence 70,” etc. The operational aspects of the first geofence 70 may include the above mentioned parameters (shape, size, location, and alarm conditions) of the first geofence 70, which may be adjusted by a user through the GUI 105 and the input device 104. The map 75 may be an online map application, for example, a map provided by a third-party website, or a stand-alone map stored on a data storage device, for example, a CD-ROM (not shown) or a hard disk (not shown).

The first geofence 70 may be represented by a graphical representation with a predetermined shape, as illustrated by the exemplary circle in FIG. 3. It is contemplated that the shape may be any regular shape, such as a square, a triangle, a polygon, etc., or any irregular shape. The graphical representation of the first geofence 70 may have a boundary (i.e., the boundary of the shape), as illustrated by the circle in FIG. 3. It is contemplated that the GUI 105 may display a list of pre-defined shapes for a user to choose to create the first geofence 70. The pre-defined shapes may include regular basic shapes, such as square, triangle, circle, polygon, etc., each with a pre-defined size, or user defined shapes, such as a predefined irregular shape with a pre-defined size. It is also contemplated that the first geofence 70 may also be created manually. The unit of the size of the pre-defined shapes may be meter, kilometer, mile, etc.

The first geofence 70 may include a center point C. The control portion 65 of the first geofence 70 may include the center point C, and a handle 73 associated with the first geofence 70. The center point C may be associated with at least one of a predetermined shape, size, color, and image, and may be associated with a location (e.g., a location 61 or a location 71) on the map 75. For example, the center point C may be displayed as a circle with a suitable size for display. The circle may have a color such as blue, or red, and/or may include an image in the circle.

The handle 73 may be overlaid on the first geofence 70 and operative (e.g., movable, selectable, clickable, etc.) by the input device 104 to reconfigure the first geofence 70. The handle 73 may be located on the boundary of the graphical representation of the first geofence 70. In the exemplary graphical representation of the first geofence 70 shown in FIG. 3, the handle 73 is located on the circle (the boundary of the first geofence 70). In some embodiments, the handle 73 may include a plurality of handles 73 evenly or unevenly distributed on the boundary of the first geofence 70 (e.g., the circle). It is contemplated that the handles 73 may be generated automatically by algorithms or manually by the user. For example, the geofence system 150 may include a selection of automatic handle generation mode and a manual handle generation mode. In the automatic handle generation mode, handles may be generated automatically. Algorithms implemented to generate a distribution of the handles 73 may differ depending on the shapes of the first geofence 70. For example, when the shape of the first geofence 70 is a circle, the handles 73 may be distributed at an interval of 30 degrees along the boundary of the first geofence 70. When the shape of the first geofence 70 is a triangle, the geofence system 150 may deposit a handle at each vertex of the triangle, and may also deposit a predetermined number of handles along each line segment of the triangle depending on the size of the triangle. In the manual handle generation mode, the user may click anywhere on the shape boundary to define a handle. It is contemplated that in the manual handle generation mode, the user may add, delete a handle, or may also change the location of a handle on the shape boundary by moving the handle along the shape boundary from one location on the boundary to another location on the boundary.

Geofence system 150 may include predetermined modes of operation. For example, in some embodiments, geofence system 150 may include two modes of operation, a proportional mode, and a non-proportional mode. In the non-proportional mode, each one of the plurality of handles 73 may be operated (e.g., clicked, selected, moved, etc.) independently. That is, operation of one handle may not affect the other handles. For example, moving a selected handle may only result in movement of the handle and adjustment of a portion of the first geofence 73 joining the selected handle to the remaining portions of the original shape of the first geofence 73. Thus, the same operations of different individual handles may yield different results (e.g., different shape and size changes of the first geofence 70). In the proportional mode, the plurality of handles 73 may be operated simultaneously through operation of any one of the handles 73. That is, operations of any one of the handles 73 may affect the other handles. Thus, the same operations of any one of the handles 73 may yield the same reconfiguration results (e.g., same shape and size changes to the first geofence 70). Moving any selected handle of the first geofence 73 may result in a proportional sizing of the shape of the first geofence 73. For example, the proportional sizing may be reducing or enlarging the first geofence 73 proportional to the distance on the map 75 of the movement of the selected handle.

The first geofence 70 may have already been configured by the user at the central control station 60 to define a geographical area where the machines 10 are authorized to operate. Every point on the first geofence 70 and defined by the first geofence 70 may be associated with a location on the map 75, and therefore, may be associated with map data, e.g., latitude and longitude. For example, the center point C may be associated with the location 61 on the map 75. The handle 73 may also be associated with a location 71 on the map 75. Although not illustrated in FIG. 3, it is contemplated that the location of each one of the machines 10 in the actual networked environment may be shown on the map 75. When a machine 10 “crosses” the virtue boundary defined by first geofence 70 (i.e., the location of the machine 10 is out of the authorized operating area defined by the first geofence 70, which may be an inclusive or exclusive geofence), an alarm may be triggered at the central control station 60 and/or at the machine 10. It is contemplated that the integrated GUI 105 may display a plurality of geofences overlaid on the map 75, defining a plurality of authorized areas which certain machines 10 may be operated. The plurality of geofences may or may not overlap with each other.

The center point C may be associated with a shape of a circle with a needle as illustrated in FIG. 3, or a shape of a small triangle, square, star, etc., and may be associated with a predetermined size and color. For example, in some embodiments, the center point C of any inclusive geofence may have a first color (e.g., red), and the center point C of any exclusive geofence may have a second color (e.g., blue), so that different types (inclusive geofences and exclusive geofences) may be easily distinguished. The center point C may be associated with map data such as latitude and longitude indicative of the location 61 of the center point C. The center point C may be selectable and movable by the input device 104. The first geofence 70 may be selected by a user through selecting the center point C with the input device 104. Selecting the center point C may be achieved through, for example, clicking the shape of the center point C by the input device 104. The center point C may be moved, by the user through the input device 104, from a first location to a second location on the map 75. The data processor 102 may calculate the distance between the first and second locations.

The size of the first geofence 70 may be represented by, for example, a radius r, as indicated by the arrowed straight line 72 extending from the center point C to a point on the first geofence 70. It is noted that the term “radius” does not necessarily limit the shape of the first geofence 70 to be a circle. Instead, the term “radius” is intended to generally refer to a characteristic distance from the center point C to a point on the first geofence 70. The arrowed line 72 is superimposed on the first geofence 70 for illustrative purposes in FIG. 3, and may not be actually displayed on the display device 101 with the map 75 and the first geofence 70. Although not shown in FIG. 3, in some embodiments, the size of the first geofence 70 (e.g., indicated by the radius r) may be displayed in a dialog box shown on the display device 101 when the center point C is selected by the input device 104.

The handle 73 may not be displayed until the first geofence 70 is selected. The handle 73 may be associated with at least one of a predetermined shape, size, color, and image. For example, the handle 73 may have a shape of a small circle, a triangle, a square, a star, etc., with an appropriate size, color, or image for display. In some embodiments, the center point C may also be treated as a special handle.

The display device 101 may display a second geofence 80 with the same center point C, same shape, and a different size as indicated by the radius r′ and the arrowed straight line 72′. The first and the second geofences 70 and 80 together may illustrate how the size of the first geofence 70 may be changed using the handle 73, and will be further described below.

### INDUSTRIAL APPLICABILITY

The disclosed geofence system and method may be applied to a networked environment to enhance management of equipment. The disclosed geofence system includes an integrated graphic user interface (GUI) having a map and a geofence overlaid on the map, as well as a control portion operative by an input device to reconfigure the geofence. The geofence may be easily reconfigured through operations of the control portion, which may include a handle and a center point associated with the geofence by a user through an input device. With the integrated GUI that integrates a map interface and a geofence configuration (reconfiguration) interface together, and with the control portion, the geofence system may enable convenient and effective geofence reconfiguration. Simultaneously, the effects of the reconfiguration may be conveniently observed through the same integrated GUI on the map by the user. Therefore, the disclosed geofence system may improve effectiveness of managing the networked environment, and may increase productivity of the networked environment.

The disclosed geofence system 150 may be used to facilitate the reconfiguration of a geofence. The display device 101 may display the integrated interactive graphic user interface (GUI) 105. More specifically, the display device 101 may display a graphical representation of the geofence overlaid on the map 75. The input device 104 may be used by the user to send a command signal (such as, clicking, selecting, moving, etc.) to the geofence system 150 during geofence reconfiguration. The data processor 102 may process signals, such as command signals from the input device 104, and map data of the map 75. The memory 103 may be used to store data processed or to be processed by the processor 102. The user may operate the input device 104, and interact with the geofence system 150 through the interactive GUI 105 to configure or reconfigure a geofence. The user may interact, through the input device 104, with the control portion (e.g., control portion 65 shown in FIG. 3) of the graphical representation of the geofence. The geofence system 150 may detect the user interaction with the control portion, and may adjust an operational aspect of the geofence based on the detected user interaction with the control portion. The detailed process of reconfiguring the geofence with the geofence system 150 is described below.

FIG. 3 illustrates how to reconfigure a geofence with a handle 73 using the disclosed geofence system 150. Referring to FIG. 3, a geofence (e.g., the first geofence 70) may be configured or reconfigured by the control portion 65 associated with the geofence. The control portion 65 may be operated by the user through the input device 104. Specifically, the control portion 65 may be selected through the input device 104, and may be moved from a first location on the map associated with the control portion to a second location on the map through the input device 104. The geofence system 150 may detect moving the control portion 65 and may adjust an operational aspect of the first geofence 70. Moving the control portion 65 may be accomplished through drag-and-drop, manual entry of new position data, or any means known in the art. In one embodiment, the user may select the control portion 65 through the input device 104, drag the control portion 65 from the first location, and drop the dragged control portion 65 at the second location. After the control portion 65 is selected, dragged, and dropped at the second location, the geofence system 150 may generate a new geofence based on the user interaction with the control portion 65. Examples of how to reconfigure a geofence using the control portion 65, which may include a handle 73 and a center point C of the geofence (e.g., the first geofence 70), will be discussed in detail below.

Shown in FIG. 3 are a first geofence 70 to be resized and a second geofence 80 resulting from resizing the first geofence 70. The first geofence 70 and the second geofence 80 are displayed simultaneously on the display device 101 for the purpose of illustrating the resizing process. In practical application, the geofences 70 and 80 may not be displayed simultaneously.

Before performing resizing, the first geofence 70 may be selected. Selecting the first geofence 70 may be accomplished by selecting the center point C of the first geofence 70 using a well known method in the art, for example, by clicking the shape associated with the center point C. Once the first geofence 70 is selected, the handle 73 may be displayed on the first geofence 70. In some embodiments, the handle 73 may include a plurality of handles, each one of which may be selectable and movable by the input device 104. The plurality of handles may be operated simultaneously or independently. In the illustration shown in FIG. 3, the handles are configured to be operated simultaneously, meaning operations of one handle will affect other handles, and the same operations on any handle will yield the same reconfiguration results. The handle 73 may be associated with a first location 71 on the map 75, and may be selected by the input device 104 and moved from the first location 71 to a second location 71′. The original handle 73, after being moved, is indicated by 73′ (hereafter “moved handle 73′”) located at the second location 71′. After the second geofence 80 is generated and shown, the moved handle 73′ may be removed from the display device 101. For illustrative purposes, the moved handle 73′ and the second geofence 80 are both shown in FIG. 3. In some embodiments, the handle 73 may be moved by the input device 104 through drag-and-drop methods. That is, the handle 73 may be selected by the input device 104, dragged from the first location 71 to the second location 71′, and dropped at the second location 71′.

The data processor 102 may calculate the distance between the first location 71 and the second location 71′ using map data associated with the first and second locations. A size indicated by the radius r′ may be calculated by the data processor 102 based on the size r of the first geofence 70, and the calculated distance between the first location 71 and second location 71′. For example, the radius r′ may be proportional to the calculated distance. The data processor 102 may generate the second geofence 80 with the same shape and center point C as that of the first geofence 70, and with the calculated new size indicated by r′. The second geofence 80 may be displayed on the display device 101, and the first geofence 70 (including the circle and the handle 73) may be removed from the display device 101. Note that the center point C of the first geofence 70 now becomes the center point of the second geofence 80. The arrowed straight line 72′ with radius r′ is only superimposed on the map 75 for illustrative purposes. In practical applications, the line 72′ with radius r′ may or may not be displayed on the display device 101. It is contemplated that when an irregular shaped geofence is re-sized, every portion of the geofence may be enlarged simultaneously based on the distance between the first location 71 and the second location 71′ so that the shape of the geofence being configured is maintained.

After the second geofence 80 is generated, new handles may be generated on the boundary of the second geofence 80 based on a preprogrammed algorithm. The new handles may not be shown until the second geofence 80 is selected, for example, through selection of the center point C. The new handles may or may not include the moved handle 73′. In other words, the handle 73, after being moved to the second location 71′, may or may not become one of the new handles of the second geofence 80. As shown in FIG. 3, the moved handle 73′ is off the boundary of the second geofence 80, meaning that the moved handle 73′ is not a handle of the second geofence 80. However, it is also contemplated that the moved handle 73′ may also be a handle of the second geofence 80 in some embodiments, and may be shown on the boundary of the second geofence 80.

Although the above example of resizing a geofence with handles is directed to increasing the size of a geofence as illustrated, it is understood that a similar procedure may be applied to reduce the size of a geofence with handles. For example, the first geofence 70 may be seen as a result of reducing the size of the second geofence 80. This reverse procedure is understandable by a skilled person in the art from the above description of resizing a geofence.

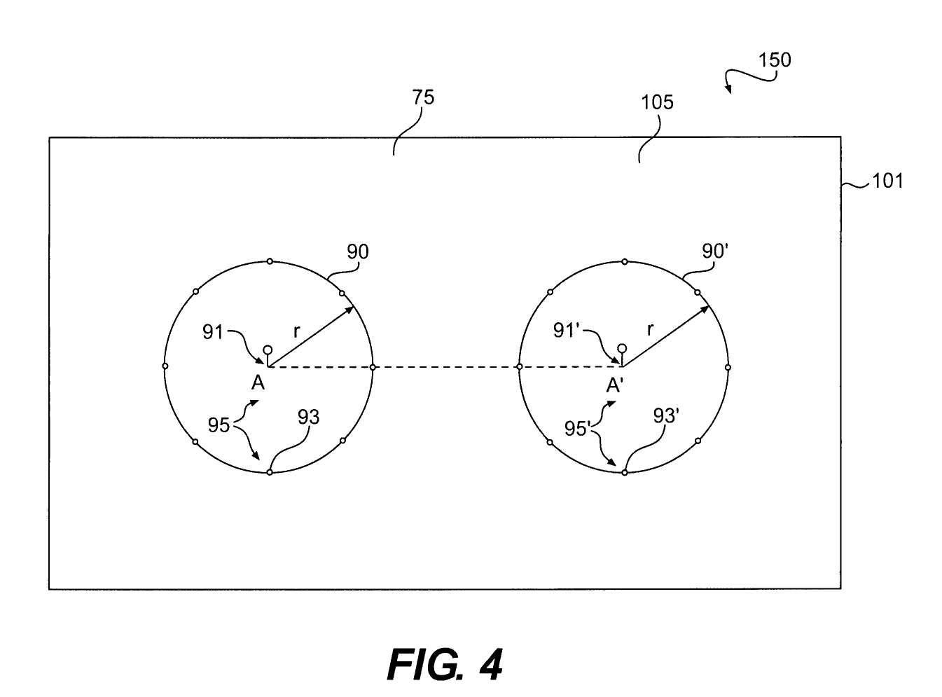

FIG. 4 provides an exemplary display of a graphical user interface of a geofence system that illustrates a reconfiguration of a geofence via user interaction with a center point associated with the geofence. Specifically, FIG. 4 describes how a first geofence 90 may be moved from a first location to a second location on the map using the center point A.

The center point A may be part of a control portion 95 associated with the first geofence 90. For illustrative purposes, center point A is referred to as a first center point. Although not shown in FIG. 4, it is contemplated the first geofence 90 may also include at least one handle 93 as a part of the control portion 95 similar to the handle 73 in the embodiment of FIG. 3. FIG. 4 shows a first geofence 90 having a circular shape with the center point A, and a size indicated by a radius r. Although labeled with different characters, the first center point A is similar to the center point C discussed previously, and thus may also be associated with at least one of a predetermined shape, size, color, image, and a first location 91 on the map 75, and may be selectable and movable by the input device 104. To move the first geofence 90, the geofence may first be selected. As discussed previously, the selection of the first geofence 90 may be accomplished, for example, by selecting the first center point A. After the first center point A is selected, the first center point A may be moved, by the input device 104, from the first location 91 on the map 75 to a second location 91′ on the map. The moved first center point A at the second location 91′ may be denoted as a second center point A′. Moving the first center point A by the input device 104 may be accomplished through drag-and-drop. That is, the first center point A may be selected by the input device 104, dragged from the first location 91, and dropped at the second location 91′.

When the first center point A is moved from the first location 91 to the second location 91′, the data processor 102 may generate a second geofence 90′, which may be associated with the same shape and size as that of the first geofence 90, and the second center point A′ at the second location 91′. The second center point A′ may be part of a control portion 95′ of the second geofence 90′. It is contemplated that the control portion 95′ may also include at least one handle 93′ on the second geofence 90′. The second geofence 90′ may be displayed on the map 75, and the first geofence 90 may be removed from the map 75. In some embodiments, the second geofence 90′ may be displayed at each movement of the first center point A when the second center point A is moved from the first location 91 to the second location 91′. By doing so, the user may dynamically observe the effect of each movement. For example, the user may observe the progressive location of the edge of the second geofence 90′, and thus may better decide where to drop the first center point A (e.g., at the second center point A′).

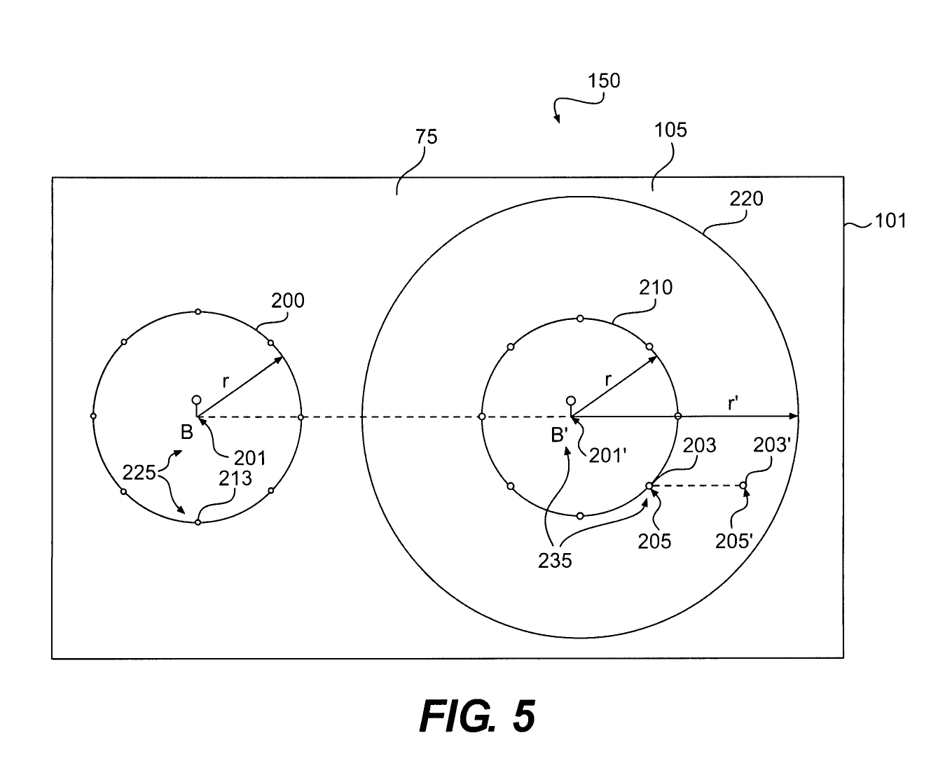

FIG. 5 provides an exemplary display of a graphical user interface of a geofence system that illustrates a reconfiguration of geofences via user interaction with both handles and center points associated with the geofences. Specifically, FIG. 5 shows how to move a geofence using the center point of the geofence to a new location, and then resize the geofence at the new location through handles.

In FIG. 5, a first geofence 200 is shown having a first center point B, and a shape (e.g., a circle) with a size indicated by a radius r. The first geofence 200 may be associated with a control portion 225, which may include the first center point B and at least one handle 213 overlaid on the first geofence 200. Similar to the center points A and C discussed previously, the first center point B may be selectable and movable by the input device 104, and may be associated with at least one of a predetermined shape, size, color, image, and a first location 201 on the map 75. The first center point B may be selected by the input device 104, and moved from the first location 201 on the map 75 to a second location 201′ on the map 75. The moved first center point B is illustrated in FIG. 5 as a second center point B′. Moving the first center point B from the first location 201 to the second location 201′ may be achieved by drag-and-drop. That is, the first center point B may be selected by the input device 104, dragged from the first location 201 to the second location 201′, and dropped at the second location 201′. After the first center point B is moved to the second location 201′, data processor 102 may generate a second geofence 210 based on the same shape and size as that of the first geofence 200, and the second center point B′ of the geofence 210. Once the geofence 210 is generated, it may be displayed on the map 75, and the first geofence 200 may be removed from the map 75.

The second geofence 210 may be associated with a control portion 235, which may include the second center point B′ and at least one handle 205 overlaid on the second geofence 210. The second geofence 210 may be resized (e.g., enlarged) using the handle 203. To use handles to resize the second geofence 210, the second geofence 210 may first be selected, which may be achieved by selecting the second center point B′ of the second geofence 210. The handle 203 may be displayed on the selected second geofence 210. As discussed previously, the handle 203 may include a plurality of handles distributed on the second geofence 210 according to a certain pattern. Similar to the handle 73 discussed in FIG. 3, the handle 203 may be associated with at least one of a predetermined shape, size, color, image, and a first location 205 on the map 75. The handle 203 may be selectable and movable by the input device 104. For example, as illustrated, the handle 203 may be selected and moved from the first location 205 on the map 75 to a second location 205′ on the map 75. The moved handle 203 located at the second location 205′ is illustrated in FIG. 5 as 203′ (hereafter “moved handle 203′”).

The data processor 102 may generate a third geofence 220 based on the second geofence 210 when the handle 203 is moved from the first location 205 to the second location 205′. The shape and center point of the third geofence 220 may be the same as that of the second geofence 210. The size (indicated by a radius r′) of the third geofence 220 may be calculated, by the data processor 102, based on the distance between the first location 205 and the second location 205′. For example, radius r′ may be proportional to the distance between the first location 205 and the second location 205′. Again, as discussed previously, the moved handle 203′ may or may not be a new handle of the third geofence 220. Once the third geofence 220 is generated and displayed on the map 75, and the second geofence 210 may be removed from the display device 101. Although geofences 200, 210, and 220 are illustrated together in FIG. 5 for discussion of the moving and resizing procedures to reconfigure the first geofence 200, it is understood that once the reconfiguration of an original geofence is completed and a new resulting geofence is generated and displayed, the original geofence may be removed from the display device 101. Therefore, upon completion of the reconfiguration process, the display device 101 may only display the final resulting geofence, i.e., the third geofence 220.

Although in above discussions in connection with FIG. 5, it is illustrated how to move and then resize a geofence, it is noted that the reverse procedure, i.e., resizing then moving a geofence using a handle and a center point, is contemplated and can be understood by a person skilled in the art. For example, the second geofence 210 may be seen as a result of resizing (i.e., reducing the size) of the third geofence 220 using a handle (e.g., 203′) on the third geofence 220, and the first geofence 200 may be seen as a result of moving the second geofence 210 using the second center point B′. In addition, while the procedural sequence has been described as discrete steps from the first geofence 200 to the second geofence 210, and then from the second geofence 210 to the third geofence 220, it is contemplated that reconfiguring the first geofence 200 to the third geofence 220 may be accomplished by simultaneously moving the first center point B and handle 213 without generating the second geofence 210. In such an embodiment, the geofence 200 may be referred to as the “first geofence 200,” and the final geofence 220 may be referred to as the “second geofence 220.”

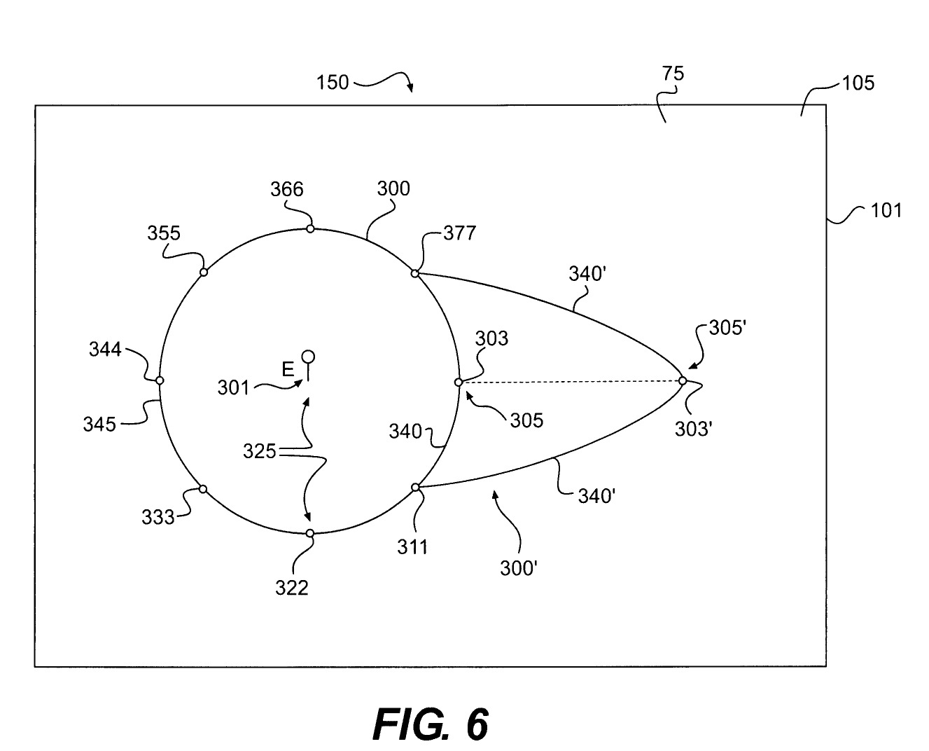

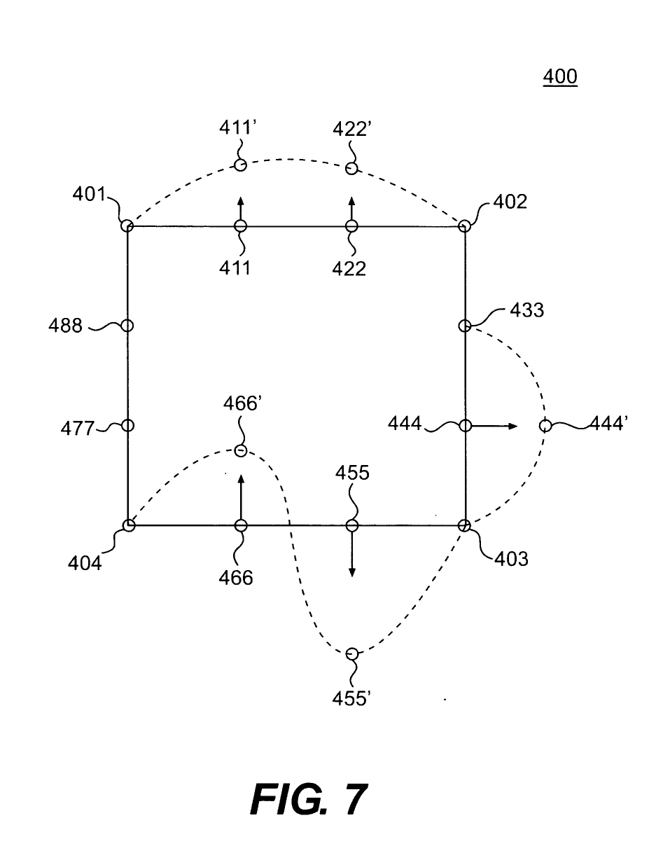

FIG. 6 provides an exemplary display of a graphical user interface that illustrates a reconfiguration of geofence via user interaction with a handle associated with the geofence. Specifically, FIG. 6 shows how the handles may be operated independently.

FIG. 6 shows a first geofence 300, represented by a circle (an example of regular shapes). The first geofence 300 includes a center point E, which may be associated with a location 301 on the map 75. The center point E may be similar to center points A, B and C. The first geofence 300 may also include a plurality of handles (e.g., 303, 311, 322, 333, 344, 355, 366, and 377) located on the boundary of the first geofence 300. Each one of the handles may be operated independently. In other words, when one handle is operated, the other handles may not be affected. As a result, the same operations of different individual handles may yield different reconfiguration results (e.g., different shapes and sizes). In addition, because the handles may be operated individually, when one handle is operated, the shape of the geofence may be changed, unlike the case shown in FIG. 3, where when the handle is moved from one location to another, the shape of the geofence is maintained. A control portion 325 may include the center point E and the handles.

For illustrative purposes, the boundary of the first geofence 300, i.e., the circle shown in FIG. 6, may be divided into two portions: a first portion 340 connecting handles 311, 303, and 377, and a second portion 345 connecting handles 311, 344, 366, etc. When the handle 303 is moved from a first location 305 to a second location 305′, the handle 303 becomes handle 303′. As a result of the movement of the handle 303, a second geofence 300′ is generated. The first portion 340 of the first geofence 300 may be changed into a portion 340′ of the second geofence 300′. Although portion 340′ is shown to be a curved portion, it is contemplated that the portion 340′ may also be straight lines connecting the handles 303′ and 311, and the handles 303′ and 377. In this exemplary embodiment, all handles except handle 303 remain their positions. Therefore, the second portion 345 remains unchanged. As a result, the newly generated second geofence 300′ has an irregular shape, the boundary of which includes the second portion 345 of the first geofence 300, and the portion 340′. The size of the second geofence 300′ is also different from that of the first geofence 300. However, in some embodiments, when handles can be moved independently, movement of some handles may cause an increase in the size of the first geofence 300, movement of some handles may cause a decrease in the size of the first geofence 300. Therefore, the overall size of the second geofence 300′ may remain the same as that of the first geofence 300, even after the individual handles are independently moved.

FIG. 6 uses a circle as the graphical representation of the first geofence 300. Other shapes, such as squares, triangles, polygons, etc., are also contemplated. In other words, when the handles can be independently operated, an original regularly-shaped geofence may be changed into an irregular shape by moving the handles. This adds flexibility to the geofence system 150 for reconfiguring a geofence to any desirable shape. The operations of the handles illustrated in FIG. 6 may be combined with the operations (i.e., moving) of the center point so that a new geofence may be generated at a new location, similar to that illustrated in FIG. 5. Detailed process of combining the operations of the independently operated handles and the center point is omitted.

FIG. 7 illustrates an exemplary embodiment of creating a geofence 400. The geofence system 150 may include a dynamic shape-creating mode, where geofence 400 may be created by the user manually. As illustrated in FIG. 7, the user may first click a first defining point 401 on the map 75. First defining point 401 may also become a handle 401. The user may move the handle 401 to a second defining point 402 on the map 75, or simply click a point on the map 75 to define the second defining point 402. Second defining point 402 may also become a handle 402. A line (which can also be a curved line although shown as a straight line) may be created linking the first defining point 401 and the second point 402. A plurality of handles, for example, handles 411 and 422 may be created, automatically or manually, and shown on the straight line connecting the first and second defining points 401 and 402.

Similarly, the user may select a third defining point 403, and a fourth defining point 404 on the map 75, and more defining points (not shown) if needed. Finally, the user may click the first defining point 401 again to form an initial closed shape for the geofence 400, as shown in square in solid lines. The initial closed shape may be any regular or irregular shapes, although it is shown as a square for illustrative purposes. As shown in FIG. 7, handles 455 and 466 may be created on a line connecting the third defining point 403 and fourth defining point 404, and handles 477 and 488 may be created on a line connecting the fourth defining point 404 and the first defining point 401. The initial square shape in solid lines may be maintained to become the shape of the geofence 400, or may be modified to create a new shape as the shape of the geofence 400. For example, the handles 411 and 422 may be moved to become handles 411′ and 422′. Accordingly, the straight line connecting the first and second defining points 401 and 402 may be changed to the dotted line connecting first defining point 401, handle 411′, handle 422′, and second defining point 402. Similarly, other handles, such as handle 444, 455, or 466, may be moved to change a portion of the square shape in solid lines to the portions shown in dotted lines. It is also contemplated that all four defining points 401, 402, 403, and 404 may be moved to make changes to the solid square shape. In this example, any desired shape may be created for geofence 400 based on the initial square shape in solid lines. As shown in FIG. 7, the handles are operated in the non-proportional mode, where the handles are operated independently. Although not illustrated in FIG. 7, it is also contemplated that after the solid square shape is created, the handles may also be operated in a proportional mode, where moving one of the handles may affect all other handles, and may result in a proportional sizing of the initial solid square shape.

It is noted that although different numerals and characters have been used to denote geofences, handles, and center points, those different numerals or characters are only used for illustrative purposes, and may not imply substantive differences among the geofences, handles, and center points in different figures. For example, the geofences 200 and 210 in FIG. 5 may be the same as the geofences 90 and 90′ illustrated in FIG. 4.

By utilizing an integrated GUI displaying the map, the geofence, and the control portion, the process of reconfiguring the geofence may be conveniently observed from the integrated GUI to achieve desired reconfiguration results. Through the control portion which may include the handle and the center point of the geofence, the geofence may be reconfigured. The reconfiguration can be performed by the user through drag-and-drop of the control portion (e.g., the handle and the center point) with the input device. The disclosed geofence system may significantly improve the geofence reconfiguration effectiveness, which may contribute to the overall efficiency of the networked environment.

It will be apparent to those skilled in the art that various modifications and variations can be made in the disclosed geofence system. Other embodiments will be apparent to those skilled in the art from consideration of the specification and practice of the disclosed embodiments herein. It is intended that the specification and examples be considered as exemplary only, with a true scope of the disclosure being indicated by the following claims.

What is claimed is:

1. A geofence system, comprising:
a display device; and
a graphical user interface displayable on the display device, the graphical user interface configured to:
display a map corresponding with a geographical area; and
provide a graphical representation of a geofence, the graphical representation overlaid on the displayed map and including a control portion responsive to an input device configured to adjust an operational aspect of at least a portion of the geofence, the control portion associated with a location on the map.

2. The geofence system of claim 1, wherein the operational aspect includes at least one of the shape, size, location, and alarm conditions associated with the geofence.

3. The geofence system of claim 1, wherein the control portion includes at least one handle overlaid on the geofence, the at least one handle configured to be selectable and movable by the input device from a first location on the map associated with the handle to a second location on the map.

4. The geofence system of claim 3, wherein the geofence is a first geofence having predetermined shape and size, and the geofence system is configured to generate a second geofence when the handle of the first geofence is selected and moved by the input device from the first location to the second location, and wherein the second geofence has the same shape as that of the first geofence, and a size calculated based on the size of the first geofence, and the first and the second locations of the selected and moved handle.

5. The geofence system of claim 3, wherein the geofence is a first geofence, and the geofence system is configured to generate a second geofence when the handle of the first geofence is selected and moved by the input device from the first location to the second location, and wherein the second geofence has at least one of the shape and size different from that of the first geofence.

6. The geofence system of claim 1, wherein the control portion includes a center point of the geofence, the center point configured to be selectable and movable by the input device from a first location associated with the center point on the map to a second location on the map.

7. The geofence system of claim 6, wherein the geofence is a first geofence, and the geofence system is configured to generate a second geofence when the center point of the first geofence is selected and moved from the first location to the second location, and wherein the second geofence includes a center point at the second location, and has the same shape and size as that of the first geofence.

8. The geofence system of claim 1, wherein the geofence is created from selection of a pre-defined shape from a list of pre-defined shapes, or from a drawing generated by the geofence system responsive to input from a user through the input device.

9. A method of reconfiguring a geofence, comprising:
displaying a graphical representation of the geofence, the graphical representation overlaid on a map associated with an interactive user interface and including a control portion responsive to an input device, the control portion associated with a location on the map;
detecting a user interaction with the control portion of the graphical representation of the geofence; and
adjusting an operational aspect of the geofence based on the detected user interaction with the control portion.

10. The method of claim 9, wherein detecting a user interaction with the control portion includes detecting a user interaction with at least one of a center point of the geofence and a handle of the geofence.

11. The method of claim 9, wherein the location on the map associated with the control portion is a first location, and wherein detecting a user interaction with the control portion includes detecting moving the control portion from the first location on the map to a second location on the map.

12. The method of claim 9, wherein adjusting the operational aspect of the geofence includes adjusting at least one of a shape, size, and location of the geofence.

13. A method of reconfiguring a geofence, comprising:
selecting a first geofence to be reconfigured and a control portion of the first geofence, the control portion associated with a first location on a map;
moving the selected control portion of the first geofence from the first location on the map to a second location on the map;
generating a second geofence based on at least one operational aspect of the first geofence; and
displaying the generated second geofence on the map.

14. The method of claim 13, wherein the control portion includes a center point of the first geofence, wherein the center point is a first center point and is associated with the first location on the map, and wherein
selecting the first geofence includes selecting the center point of the first geofence;
moving the selected control portion includes moving the selected center point from the first location on the map to the second location on the map; and
generating the second geofence includes generating the second geofence with the same shape and size as that of the first geofence, and with a second center point located at the second location.

15. The method of claim 13, wherein the control portion includes a plurality of handles, the method further including operating the plurality of handles simultaneously in a proportional mode, where moving any one of the handles results in a proportional sizing of the first geofence.

16. The method of claim 13, wherein the control portion includes a plurality of handles, the method further including operating each one of the handles independently in a non-proportional mode, where moving one selected handle results in an adjustment of a portion of the geofence associated with the selected handle.

17. The method of claim 13, wherein the first geofence is created through:
defining a plurality of defining points on the map;
generating a plurality of lines connecting the plurality of defining points to form a closed shape;
generating a plurality of handles on the lines; and
maintaining or modifying the closed shape to form the first geofence.

18. The method of claim 16, wherein
selecting the control portion includes selecting one of the handles, wherein the selected handle is associated with the first location on the map;
moving the selected control portion includes moving the selected handle from the first location on the map to the second location on the map; and
generating the second geofence includes generating the second geofence with at least one of the shape and size different from that of the first geofence.

19. The method of claim 13, wherein the control portion includes a center point and a handle associated with the first geofence, and wherein
selecting the control portion includes selecting the center point and selecting the handle;
moving the control portion includes moving the center point from a first location associated with the center point on the map to a second location associated with the center point on the map, and moving the handle from a first location associated with the handle on the map to a second location associated with the handle on the map; and
generating the second geofence includes generating the second geofence with at least one of the shape and size different from that of the first geofence, and with a center point located at the second location associated with the selected and moved center point.

20. The method of claim 13, wherein the control portion includes a center point and a handle associated with the first geofence, and wherein
selecting the control portion includes selecting the center point and selecting the handle;
moving the control portion includes moving the center point from a first location associated with the center point on the map to a second location associated with the center point on the map, and moving the handle from a first location associated with the handle on the map to a second location associated with the handle on the map; and
generating the second geofence includes generating the second geofence with a size different from that of the first geofence, with the same shape at that of the first geofence, and with a center point located at the second location associated with the selected and moved center point.
